(19) United States
(12) Patent Application Publication
(10) Pub. No.: US 2022/0316949 A1
(43) Pub. Date: Oct. 6, 2022

(54) Device and related method for the automatic control of the color tone of a reel of thread

(71) Applicant: THEMA 2 S.R.L., Moglia, MANTOVA (IT)

(72) Inventors: Claudio MICHELINI, Moglia, MANTOVA (IT); Stefano BARALDI, Moglia, MANTOVA (IT); Alessandra ROSSI, Moglia, MANTOVA (IT); Giovanni GUERZONI, Moglia, MANTOVA (IT); Luciano SPOLLON, Moglia, MANTOVA (IT)

(21) Appl. No.: 17/620,251

(22) PCT Filed: Jun. 18, 2020
(86) PCT No.: PCT/IB2020/055679

§ 371 Date: Dec. 17, 2021

(30) Foreign Application Priority Data
Jun. 20, 2019 (IT) 102019000009636

(51) Int. Cl. G01J 3/50; B65H 63/00; G01N 21/31; G01N 21/89; G01J 3/02; D02G 3/34

(52) U.S. Cl. CPC G01J 3/501; B65H 63/006; G01N 21/31; G01N 21/8915; G01J 3/0202; D02G 3/346; B65H 2701/31; G01N 2021/3181; G01N 2021/3155

(57) ABSTRACT

A device for automatic control of color tone of a reel of thread includes a frame supporting an arm on which a reel of thread is loadable, a meter configured to project a measuring beam onto a cylindrical portion of the reel of thread, the meter having a camera and an illuminator aligned with the camera, the illuminator being multispectral and configured to illuminate the reel of thread with different wavelengths. A computer provided with a screen with graphic interface and connected to the meter processes the classification of the reel of thread loaded on the arm on the basis of measurements performed by the meter.

It is the object of the present invention a device for automatically reading the color tone of a reel of textile thread (for example, for fabrics or ropes), and a related classification method.

In the textile field, the responsibility for the quality control of the thread produced rests with the supplier, who in practice indicates a sample of thread as the reference for the color tone of the whole subsequent production. The mismatch between the actual tone of the fabric produced and the sample tone translates into penalties for the yarn supplier.

In fact, the non-uniformity of the color of the reels of thread used, by way of explanation but not by way of limitation, for the production of a fabric is clearly visible in the final fabric, which has darker or lighter linings with respect to the base color.

Currently, the control of the color tone of the reels of thread is entrusted to the experience of specialized operators, who carry it out in a completely manual manner, i.e., the reel is placed in full daylight, in a well-lit room, and compared with the naked eye against a reference sample, or fabric samples are produced alternatively woven with a few centimeters of sample thread alternating with a few centimeters of single numbered reels of thread to be compared with the sample reel itself, the comparison being always performed with the naked eye. It is clear that the assessment of the operator, although specialized, is still rather subjective and therefore a source of errors. It has been noted that statistically, following a shift and therefore an operator change, the verification of the color tone may give very different results.

It is the object of the present invention to solve the above issues.

Such an object is achieved by a device for the automatic control of the color tone of a reel of thread in accordance with claim 1, and by a related color tone classification method in accordance with claim 10. The dependent claims describe preferred embodiments of the invention.

The features and advantages of the device according to the present invention will be evident from the following description, given by way of explanation and not by way of limitation in accordance with the attached Figures, in which:

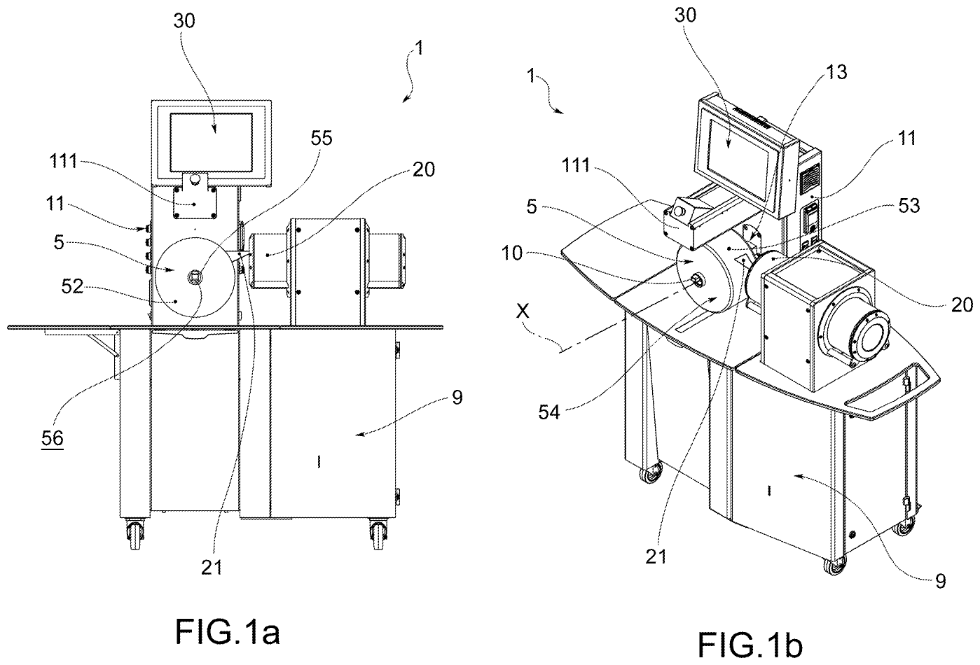

FIGS. 1A and 1B respectively show a front view and an axonometric view of a device for the automatic control of the color tone according to the present invention;

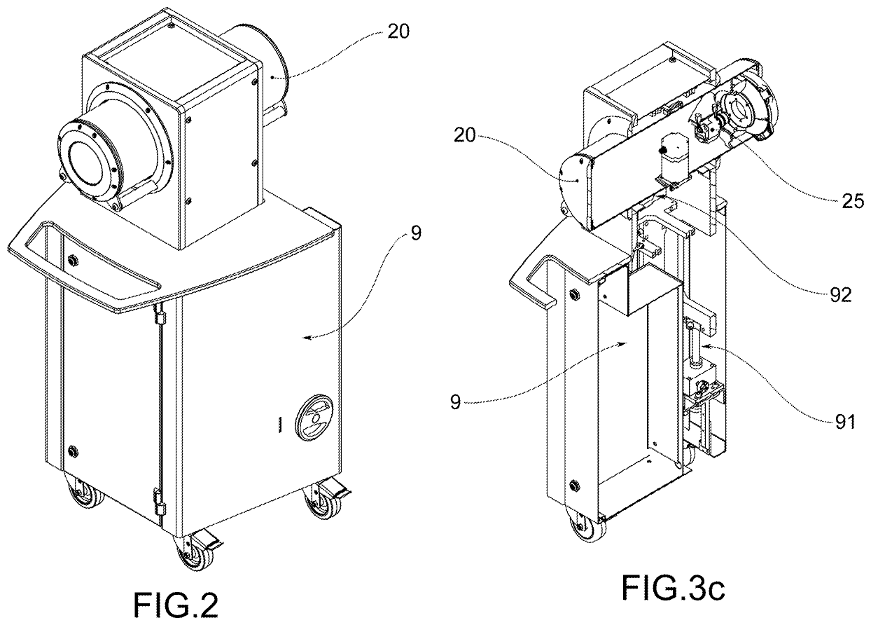

FIG. 2 shows a component of the device of FIG. 1, in particular, it shows the color measuring device in an axonometric view;

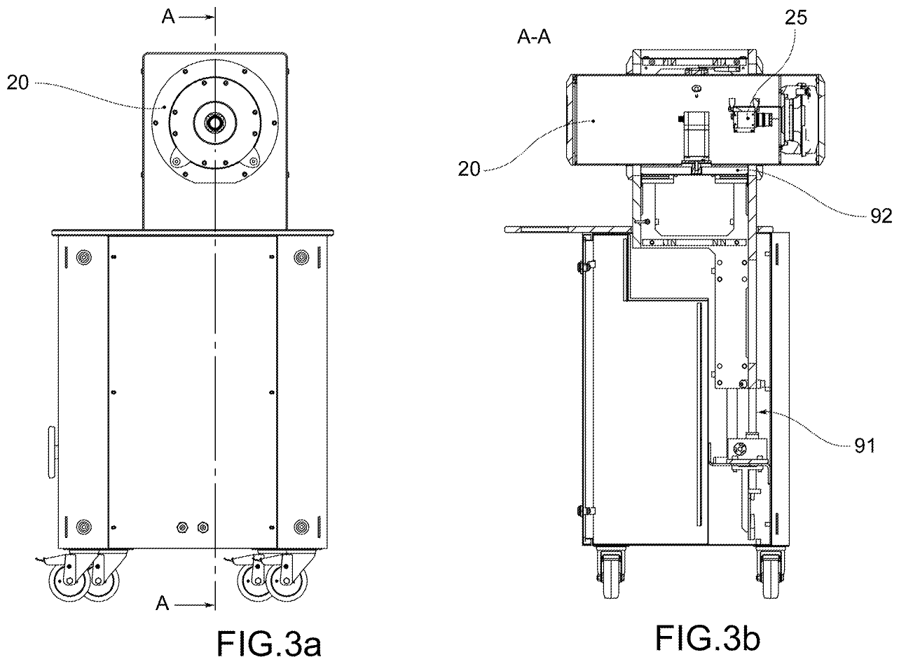

FIGS. 3A, 3B and 3C respectively show a front view, a sectional view, and an axonometric sectional view of the color measuring device of FIG. 2.

With reference to the accompanying Figures, reference numeral 1 overall indicates a device for the automatic control of the color tone of a reel of thread. The device 1 comprises a frame 11 which supports an arm 10 on which it is possible to place a reel of thread 5 to be analyzed.

The reel of thread 5, visible for example in FIG. 1, consists of thread wound on a reel 55. Looking at the reel of thread 5 from the front, it may be noticed that the wound thread forms a body 52 for which it is possible to define a cylindrical portion 53, interposed between two tapered portions 54. Looking at the reel from the side, the reel 55, provided with a hole 56 for loading the reel of thread 5 on the arm 10 of the device 1 for the automatic control of the color tone, is visible.

The arm 10 is equipped with a rear shoulder 13, adapted to make an abutment for the reel 55 of the reel of thread 5. The presence of the rear shoulder 13 allows positioning the reel of thread 5 in the correct position for the measurement step.

The device 1 comprises at least one color measuring device 20, adapted to project a measuring beam 21 onto the reel of thread 5. In particular, the meter 20 projects a measuring beam 21 at the arm 10, so that, when the reel of thread 5 is loaded onto the arm 10, the measuring beam 21 intercepts the center line of the cylindrical portion 53 of the reel of thread.

Having defined as X the longitudinal axis of development of the arm 10, the meter 20 projects the measuring beam 21 orthogonally with respect to the axis (X).

Preferably, the meter 20 is positioned on a carriage 9 which is separable from the frame 11. The meter 20 is connected to a computer (not shown) provided with a screen 30 with a graphical user interface.

Preferably, the meter 20 is provided with vertical movement means 91, adapted to lift and lower the meter with respect to the arm 10 along the vertical axis.

Preferably, the meter 20 is provided with horizontal movement means 92, adapted to move the meter closer and further away with respect to the arm 10 along a horizontal axis.

The meter 20 allows obtaining the difference in tone of the reel under observation (target reel) with respect to a reference sample (sample reel). In particular, the meter 20 performs a multispectral analysis of the reel of thread 5, using a camera and an illuminator, suitably synchronized with the reading of the camera. It should be noted that the camera allows capturing images (up to eight) with the sample illuminated with eight types of light at various frequencies in the visible (UV light, BLUE light, GREEN light, REDDISH PURPLE light, RED light, INFRA RED light, FAR RED light, WHITE light).

The meter 20 therefore comprises a camera 25 and an illuminator, positioned aligned with the camera 25.

Preferably, the camera is high resolution monochrome.

Preferably, the illuminator is multispectral with eight built-in LEDs, each adapted to illuminate the target with a specific wavelength.

The meter 20, as a result of the measurement, provides a number which considers together the average intensity of the color of the target reel of thread 5, photographed for all the eight wavelengths emitted. If the eight results are all 0, it means that all the pixels with each light emitted are saturated with black. If the 8 results are all 255, it means that all the pixels with each light emitted are saturated with white.

An eight-dimensional space was thus defined (one dimension for each wavelength emitted) with the same properties as a Euclidean space. Two reference points are defined in such an eight-dimensional space:
a midpoint, which has as coordinates the eight average saturations measured for the reference sample (sample reel);
a black point, corresponding to the black saturation point.

The measurement on the reel under analysis (target reel) is calculated as the distance with respect to the midpoint and to the black point.

In detail, therefore, having obtained the eight average saturations as measurement, they are considered as coordinates of a point.
P≡(s1, s2, s3, s4, s5, s6, s7, s8)
s1=average saturation with UV light
s2=average saturation with BLUE light
s3=average saturation with GREEN light
s4=average saturation with REDDISH PURPLE light
s5=average saturation with RED light
s6=average saturation with INFRA RED light
s7=average saturation with FAR RED light
s8=average saturation with WHITE light

From which the distance from the black point (i.e., from the point completely saturated to black) is obtained, calculated as the norm of the point:

$$‖ P ‖ = \sqrt{{\sum }_{n = 1}^{8} ( {s}_{n}^{2} )}$$

This result numerically expresses how intense the color observed by the meter is.

This is a number ranging from 0.0 to 721.25, and the unit of measurement is referred to as “are”. By definition, therefore, the distance between a black color sample at all illuminations and a white color sample at all illuminations is 721.25 “ares”.

It is also the object of the invention a method for the automatic control of the color tone of a reel of thread.

The method involves an initial step of setting the reference color, i.e., the acquisition of a color sample parameter (sample reel). Such a step involves loading a sample reel of thread onto the arm 10 of the device 1 and projecting the measuring beam 21 on a cylindrical portion of the reel. The meter detects the eight average saturations of the reference sample (sample reel) and calculates the “midpoint” and “black point” reference points.

Once the setting has been completed, the method involves a step of measuring the color of the reel, i.e., acquiring the color of the reel to be classified. Such a step involves loading the reel of thread to be classified onto the arm 10 of the device 1 and projecting the measuring beam 21 on a cylindrical portion 53 of the reel. The meter detects the eight average saturations of the target reel of thread.

At this point the eight average saturations of the target reel are classified by comparison with the “midpoint” and “black point” and the measurement on the reel is calculated as the distance with respect to the midpoint and the black point.

Thereby, it is possible to accurately establish the correspondence of the “reel color” with the “sample color”, and, in case of mismatch, have an indication of how much lighter or darker the “reel color” is compared to the “sample color”.

Therefore, the color acquisition step (both of the sample reel and of the reel to be classified) occurs on the basis of illumination with eight types of light at various frequencies in the visible (UV light, BLUE light, GREEN light, REDDISH PURPLE light, RED light, INFRA RED light, FAR RED light, WHITE light).

Preferably, the device 1 further allows the classification of the reels of thread 5 on the basis of weight (gr), diameter (mm) and density (gr/cm3).

Preferably, the device 1 comprises, at the arm 10, a load cell for measuring the weight of the reel of thread 5 once the latter is positioned on the arm 10.

Preferably, the device 1 comprises a bridge 111, fastened to the frame 11, arranged above the arm 10. Preferably, the bridge 111 extends beyond the arm 10. The bridge 111 is provided with a longitudinal rail along which a detector slides. Such a detector is capable of projecting a detection beam onto the reel of thread 5. In particular, the detector projects a detection beam at the arm 10, so that, when the reel of thread 5 is loaded onto the arm 10, the measuring beam 21 intercepts the body 52 of the reel of thread. Since the detector is slidable along the rail, it is capable of projecting the detection beam along the whole body 52 of the reel of thread (i.e., both along the cylindrical portion 53 and along the tapered portions 54). Advantageously, therefore, the detector is capable of detecting the exact geometry of the reel of thread loaded onto the arm 10.

The reel classification method, based on weight (gr), diameter (mm) and density (gr/cm3), comprises the steps of:
loading the reel of thread 5 onto the arm 10, provided with a load cell;
measuring the weight: detection of the gross weight of the reel of thread loaded on the arm 10, calculation of the net weight of the thread by subtracting the weight of the reel 55;
measuring the volume: activation of the detector, sliding along the rail, and recording of a plurality of geometry measurements of the reel, calculation of the total volume of the reel, calculation of the net volume of the thread by subtracting the volume of the reel 55:
measuring the density: calculation of the density of the thread based on the weight and volume previously recorded.

At this point, the weight, volume, and density values are classified in comparison with previously set reference values.

Advantageously, the measurement of the volume of the reel of thread 5, and in particular the measurement of the diameter, is used by the meter 20 to center the focus (autofocus) on the center line of the cylindrical portion 53 of the reel of thread.

It is therefore evident that the method for the automatic classification of the color tone of a reel of thread in accordance with the present invention, returns to the operator, in a convenient single number, the result of an in-depth analysis of the color of the target.

Furthermore, since the automatic classification of the color tone is based on the analysis of how the target color responds to all possible light sources, the resulting measurement is extremely precise.

Innovatively, a device for the automatic control of the color tone of a reel of thread, and a related classification method in accordance with the present invention, allows the measurements taken on the reel to be objective, and therefore to make the classification objective and error-free.

Advantageously, therefore, the device and method described herein allow the measurement and the classification of the reels of thread to be fully automatic, with the dual purpose of ensuring absolute objectivity in the assessment and of reducing the cost of the labor used for the control itself and especially for all the possible, rather expensive, complaints resulting from subjective assessments of the quality of the reels of thread. Such an aspect is very important, especially for high-end product categories.

Advantageously, therefore, the device and method described herein have the following technical advantages:
they allow excluding the impact of external light sources, which therefore do not affect the measurement;
they allow excluding the effects due to the surface roughness of the reel of thread, which therefore do not affect the measurement;
they allow excluding the effects due to the geometry of the reel of thread, which therefore do not affect the measurement;
they allow for an automatic positioning with Auto-Focus.

It is apparent that those skilled in the art may modify the object described above, without departing from the scope of protection as defined by the following claims.

1-12. (canceled)

13. A device for automatic control of color tone of a reel of thread, comprising:
a frame supporting an arm on which a reel of thread is loadable;
a meter configured to project a measuring beam onto a cylindrical portion of the reel of thread, said meter comprising a camera and an illuminator aligned with the camera, said illuminator being multispectral and configured to illuminate the reel of thread with different wavelengths;
a computer provided with a screen with a graphic interface and connected to the meter, adapted to process a classification of the reel of thread loaded on the arm based on measurements performed by the meter,
wherein the camera is high resolution monochrome.

14. The device of claim 13, wherein the multispectral illuminator comprises eight LEDs, and each LED projects a light at a precise frequency in the visible.

15. The device of claim 14, wherein the multispectral illuminator projects UV light, BLUE light, GREEN light, AMARANTO light, RED light, INFRA RED light, FAR RED light, and WHITE light.

16. The device of claim 13, wherein the meter is provided with vertical movement means, configured to lift and lower the meter with respect to the arm along a vertical axis, and horizontal movement means, configured to move the meter closer and further away from the arm along a horizontal axis.

17. The device of claim 13, wherein the meter is arranged on a carriage separable from the frame.

18. The device of claim 13, wherein the meter projects the measuring beam orthogonally with respect to a longitudinal axis (X) of development of the arm to center a center line of the cylindrical portion of the reel of thread.

19. The device of claim 13, further comprising, at the arm, a load cell for detecting weight of the reel of thread loaded on the arm.

20. The device of claim 13, comprising a bridge, fixed to the frame and above the arm, provided with a rail for sliding of a detector configured to project a detection beam on a body of the reel of thread loaded on the arm, to detect volume of the reel of thread.

21. A method for automatic control of color tone of a reel of thread, said method comprising:
providing a device for automatic control of color tone of a reel of thread, comprising:
a frame supporting an arm on which a reel of thread is loadable;
a meter configured to project a measuring beam onto a cylindrical portion of the reel of thread, said meter comprising a camera and an illuminator aligned with the camera, said illuminator being multispectral and configured to illuminate the reel of thread with different wavelengths;
a computer provided with a screen with a graphic interface and connected to the meter, adapted to process a classification of the reel of thread loaded on the arm based on measurements performed by the meter, wherein the camera is high resolution monochrome;
setting a reference color;
loading a sample reel of thread onto the arm of the device and projecting the measuring beam on a cylindrical portion of the sample reel;
detecting through the meter eight average saturations, one for each light frequency, wherein
S1=average saturation with UV light,
S2=average saturation with BLUE light,
S3=average saturation with GREEN light,
S4=average saturation with REDDISH PURPLE light,
S5=average saturation with RED light,
S6=average saturation with INFRA RED light,
S7=average saturation with FAR RED light,
S8=average saturation with WHITE light;
defining “sample color” a point having coordinates S1, S2, S3, S4, S5, S6, S7, S8;
measuring a color of the reel of thread to be analyzed;
loading the reel of thread to be analyzed onto the arm of the device and projecting the measuring beam on the cylindrical portion of the reel;
detecting through the meter eight average saturations, one for each light frequency, wherein
s1=average saturation with UV light,
s2=average saturation with BLUE light,
s3=average saturation with GREEN light,
s4=average saturation with REDDISH PURPLE light,
s5=average saturation with RED light,
s6=average saturation with INFRA RED light,
s7=average saturation with FAR RED light,
s8=average saturation with WHITE light;
defining “reel color” the point having coordinates s1, s2, s3, s4, s5, s6, s7, s8; and
classifying the color of the reel as a distance of the “reel color” with respect to the “sample color”.

22. The method of claim 21, wherein said device for automatic control of color tone of a reel of thread further comprises at the arm, a load cell for detecting weight of the reel of thread loaded on the arm and a bridge, fixed to the frame and above the arm, provided with a rail for sliding of a detector configured to project a detection beam on a body of the reel of thread loaded on the arm, to detect volume of the reel of thread, said method further comprising:
classifying the reel of thread on the basis of weight, diameter and density, the classifying step comprising:
measuring a weight of the reel of thread loaded on the arm through the load cell, calculating a net weight of the thread by subtracting the weight of the reel;
measuring a volume of the reel of thread by activating the detector sliding along the rail, and recording a plurality of geometry measurements of the reel, calculating a total volume of the reel, and calculating a net volume of the thread by subtracting the volume of the reel; and
measuring density by calculating the density of the thread based on the net weight and net volume previously recorded.

23. The method of claim 22, wherein the geometry measurements recorded during volume measurement are used to achieve focusing of the meter and/or centering of the measuring beam with respect to a center line of the cylindrical portion of the reel of thread loaded on the arm.
